(19) United States
(12) Patent Application Publication
(10) Pub. No.: US 2006/0050908 A1
(43) Pub. Date: Mar. 9, 2006

(54) Personalized surround sound headphone system

(75) Inventors: Eugene Shteyn, Cupertino, CA (US); Rajeev Varshneya, Cupertino, CA (US)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/537,515

(22) PCT Filed: Dec. 4, 2003
(86) PCT No.: PCT/IB03/05785

§ 371 Date: Jun. 3, 2005

Related U.S. Application Data
(60) Provisional application No. 60/431,435, filed on Dec. 6, 2002.

(51) Int. Cl. H04R 5/02; H04R 1/10

(52) U.S. Cl. 381/309; 381/74

(57) ABSTRACT

A system and method determines parameters (170) for rendering headphone audio information, based on a user's preferred acoustic rendering in a non-headphone environment. A user configures a loudspeaker-based system for a preferred ambiance. Microphones (150) on a head-mounted device then detect the audio signals received by the user in this environment. These detected signals are compared to the audio information that is being provided by the user's audio system and the differences are used to characterize the user's particular environment. Based on this characterization, when the user uses a headphone device (250) to listen to the audio information, a headphone driver (260) modifies the audio information to produce audio signals at the speakers in the user's headphone (250) to effectively reproduce the audio signals that would have been produced at the user's ears by the loudspeakers (110) in the user's particular environment.

This invention relates to the field of consumer electronics, and in particular to a headset system that is configured to store parameters that facilitate the rendering of surround sound according to a user's preference.

Surround sound, as used herein, corresponds to a rendering of audio material that provides a sense of ‘depth’, or three dimensional (3-D) ‘realism’, to the user. Generally, a combination of phase-shifts, time-delays, reverberations, and the like are used to effect this 3-D realism, based on the psychoacoustic characteristics associated with the human audio-sensory system. The time-lag between received sounds in a user's left ear and right ear, for example, evokes a sense of direction to the source of the sounds. The amount of echo, or reverberation, provides a sense of the environment common to the source and the user. The phase-shift of the received sounds provides a further resolution of the direction and the surrounding environment.

The term ‘ambiance’ is commonly used to represent the general sense of space, or 3-D realism, that is provided by a surround sound system, and techniques are commonly available to simulate a variety of ambiance conditions, regardless of the user's actual environment. For example, common surround sound systems can be configured to simulate a “concert hall” ambiance, a “nightclub” ambiance, an “outdoor” ambiance, and so on. Each of these ambiance conditions are effected by applying a particular set of parameters, such as the aforementioned phase-shift, time-delay, and reverberation parameters, to the original audio information before the information is projected to the user via a plurality of speakers or other transducers. Generally, the source information includes “right” and “left” audio information channels, and the surround sound system applies the set of parameters to produce select combinations, such as a particular sum and difference between the sounds projected from corresponding left and right speakers, as well as particular combinations of the channels for projection from an optional center speaker or rear speakers.

Generally, the projected, or simulated, ambiance effects are best perceived at one locale in the user's environment, relative to the location of the speakers or other transducers that are providing the effects; this locale is commonly termed the ‘sweet-spot’ of the surround sound system. Other locales in the user's environment will provide the ambiance effects, but to a lesser degree, or with a lesser sense of realism. Headphones allow for a substantially invariant ambiance effect, because the relationship of the transducers to the user's audio-sensory system remains substantially constant.

U.S. Pat. No. 5,742,689, “METHOD AND DEVICE FOR PROCESSING A MULTICHANNEL SIGNAL FOR USE WITH A MICROPHONE”, issued to Timothy J. Tucker and David M. Green on 4 Jan. 1996 discloses a surround-sound decoder for headphones. This invention allows the placement of phantom loudspeakers in a virtual room, to create the desired ambiance. Recognizing that each person's perception of sounds differs, because of the effects of physical factors, such as the size and shape of the person's head, the user is provided the option of configuring the system by ranking a series of test tones for best performance, relative to elevation and front/rear localization. From this ranking, a particular “head-related” transfer function (HRTF), or “head-model” is selected as the model of a head that provides parameters that are most likely to provide a realistic 3-D effect for the particular user.

U.S. Pat. No. 4,748,669, “STEREO ENHANCEMENT SYSTEM”, issued to Arnold Klayman on 31 May 1988 discloses a sum-difference based enhancement system that selectively boosts or attenuates different frequency components of the difference signal between the left and right channels, to improve the perception of reflection and reverberant fields. The amount of boost or attenuation is fixed, based on the directional frequency response of the average human ear. The principles of the '669 invention can be extended for surround-sound applications by determining the frequency response of the human ear for rear sounds, from which the response for side sounds is subtracted. U.S. Pat. No. 5,970,152, “AUDIO ENHANCEMENT SYSTEM FOR USE IN A SURROUND SOUND ENVIRONMENT”, issued also to Arnold Klayman, on 19 Oct. 1999, discloses an enhancement to the sum-difference technique, wherein the surround channels are blended, to eliminate the perception of the surround sound speakers as point sources.

Although the above '689 patent attempts to provide an individualized set of parameters for each user, or each class of user having the same head-model, the selection of the appropriate head-model is based indirectly upon the user's response to a set of test signals. In the sum-difference applications such as those disclosed in the above '152 and '669 patents, a fixed set of parameters is generally employed, independent of a user's preferences.

It is an object of this invention to provide a headphone rendering system that is personalized to an individual user's preferences. It is a further object of this invention to provide a headphone characterization system that determines the appropriate parameters for providing a headphone-based ambiance, based on a preferred acoustic environment. It is a further object of this invention to provide a headphone rendering system that allows for the storage of a plurality of characterizations corresponding to a variety of user preferences. It is a further object of this invention to provide sound-effects parameters, including noise-cancellation parameters, for enhancing the headphone-based ambiance.

These objects, and others, are achieved by a system and method that determines the parameters that are to be used for rendering headphone audio information based on a user's preferred acoustic rendering in a non-headphone environment. A user configures a conventional loudspeaker-based audio system for a preferred ambiance, and then dons a head-mounted device that includes a plurality of microphones. The microphones detect the audio signals that are being presented to the user during the user's preferred renderings in this particular environment. These detected audio signal are compared to the audio information that is being provided by the user's audio system, and the differences between what is being provided by the audio system and what is being received at the locale of the user's ears is used to characterize the user's particular environment. Subsequently, when the user uses a conventional headphone device to listen to the audio information, in lieu of the aforementioned loudspeakers, a headphone driver modifies the audio information from the audio system to produce audio signals at the speakers in the user's headphone, based on the characterization of the user's particular environment, to effectively reproduce the audio signals at the locale of the user's ears that would have been produced at the user's ears by the conventional loudspeakers in the user's particular environment.

The invention is explained in further detail, and by way of example, with reference to the accompanying drawings wherein:

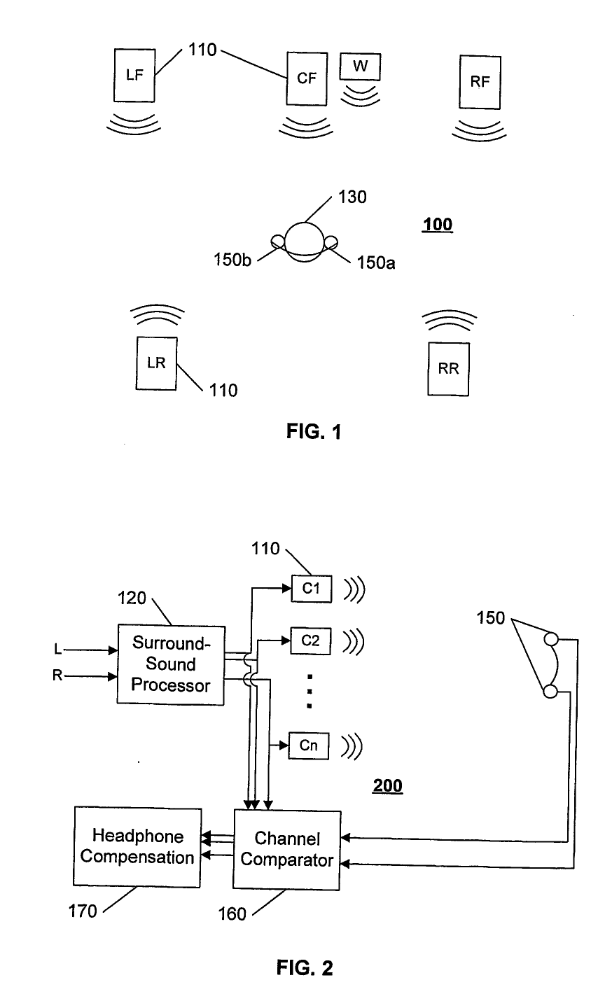

FIG. 1 illustrates an example acoustic environment for characterization in accordance with this invention.

FIG. 2 illustrates an example characterization system for determining headphone compensation factors corresponding to an acoustic environment in accordance with this invention.

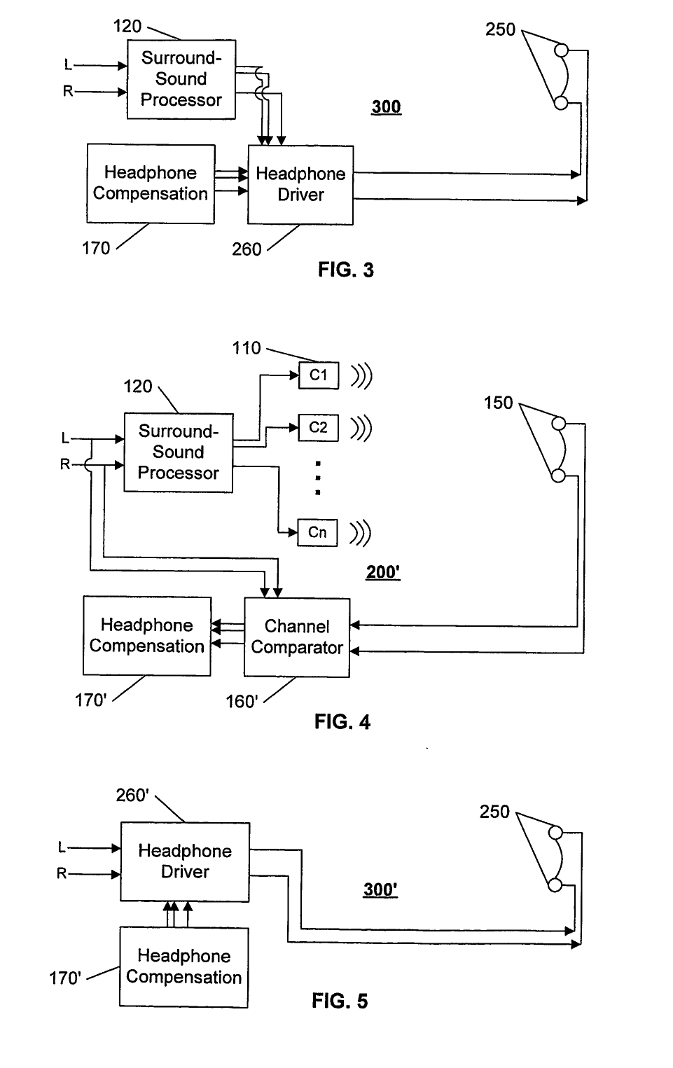

FIG. 3 illustrates an example rendering system for recreating an acoustic environment in a headphone-based audio system in accordance with this invention.

FIG. 4 illustrates an alternative example characterization system for determining headphone compensation factors corresponding to an acoustic environment in accordance with this invention.

FIG. 5 illustrates an alternative example rendering system for recreating an acoustic environment in a headphone-based audio system in accordance with this invention.

Throughout the drawings, the same reference numerals indicate similar or corresponding features or functions.

FIG. 1 illustrates an example acoustic environment 100, wherein a user 130 receives sound waves from a plurality of speakers 110. For ease of reference, the speakers 110 are hereinafter defined as loudspeakers 110, to distinguish these speakers from the speaker-transducers in a conventional audio headphone. FIG. 1 illustrates a typical “Surround Sound 5.1” configuration, wherein the sound waves are produced from five wide-range speakers, and one bass, or “woofer” speaker W. The five midrange loudspeakers are typically arranged in a left, right, and center “front” set of loudspeakers (LF, RF, and CF), and a left and right “rear” set of loudspeakers (LR and RR). Depending upon the location of the user 130 relative to each of the loudspeakers 110, the user 130 receives sound waves from each of the loudspeakers 110 in different relative amplitudes, at different relative phases, with different reverberation, and so on. These relative amplitudes, phases, reverberations, and so on, create the desired ambiance effect at the location of the user 130. In a preferred embodiment, and as in most conventional surround sound systems, the user 130 is provided options for adjusting the sounds that are emanated from each of the loudspeakers 110, to achieve a desired ambiance.

In accordance with this invention, when the user 130 is satisfied with the ambiance that is created by the loudspeakers 110, the user 130 dons a head-mounted device that includes a plurality of audio detectors, or microphones, illustrated as devices 150 in FIG. 1. These devices 150 are configured to detect the audio signals that are actually received at the locale of the user's ears when the user is perceiving the desired ambiance. Although only two audio detectors 150 are illustrated, one of ordinary skill in the art will recognize, in view of this disclosure, that any number of detectors 150 may be used to detect the audio signals that are actually received at the locale of the user 130.

Preferably, the detectors 150 are located in an acoustically-corresponding location of speakers in a conventional surround-sound headphone, such that a reproduction of the sounds received at the detectors 150 via such speakers will reproduce the desired ambiance. For example, if the sounds are recorded from the detectors 150 and then played-back via speakers that are at an acoustically-corresponding location as each of the detectors 150, one would expect that the perceived ambiance would be equivalent. The term acoustically-corresponding location is used above to include physically different locations of the detectors 150 and the speakers, based on the particular audio characteristics of each, including their detection or projection profiles. For ease of reference and understanding, a device's ‘location’ as used hereinafter refers to a device's acoustic-location, and is understood to include minor adjustments in physical location based on the device's acoustic characteristics.

In order to provide the equivalent ambiance while rendering audio content material, without actually having to render each content material in the acoustic environment 100 and recording the received audio signals at the detectors 150 for subsequent play-back, a system in accordance with this invention records a characterization of the acoustic environment. Subsequent playback through headphones is effected by modifying the audio signals based on this characterization, to recreate the ambiance that was in effect when the characterization was produced.

FIG. 2 illustrates an example characterization system 200 for determining headphone compensation factors corresponding to an acoustic environment 100 in accordance with this invention. In this system 200, a surround-sound processor 120 provides audio signals to a plurality of channels C1, C2, . . . Cn, each of which provides audio sounds via loudspeakers 110. Modified forms of these sounds are detected by audio detectors 150, which are preferably worn by the user at the location that provides the best perception of the desired ambiance. The modification of the sounds from the loudspeakers 110 are dependent upon the placement of the loudspeakers 110 relative to the detectors 150, the echoes and phase shifts produced by structures in the vicinity of the loudspeakers 110, the echoes and phase shifts produced by the shape of the user's body or other items in the vicinity of the detectors 150, and so on.

A comparator 160 compares the audio signals from the detectors 150 to the audio signals that are provided to each channel C1, C2, . . . Cn, to determine how these signals are modified as they are propagated from the loudspeakers 110 to the detectors 150. Using conventional signal processing techniques, the differences between the audio signal at each channel C1, C2, . . . Cn, and each detector 150 is characterized with respect to amplitude, phase, and reverberation. As would be evident to one of ordinary skill in the art, differences with regard to other signal parameters may also be characterized. In a preferred embodiment, to ease the characterization task, signals with known characteristics are communicated to each channel C1, C2, . . . Cn to facilitate the characterization of the modifications that are introduced to these known signals as they are propagated to the detectors 150.

The differential characterizations are stored as a set of headphone compensation parameters 170, which are preferably an inverse of the characterization of the differences, as discussed further below. Preferably, the parameters 170 are stored in a format that is common to conventional signal processing applications, or in a format that facilitates transfer among a variety of signal processing devices, such as XML (eXtended Markup Language) or others.

As noted above, most conventional surround-sound systems allow the user to adjust the relative volume and other characteristics of the sounds from the loudspeakers 110, to achieve an ambiance that is personalized to the particular user. In a preferred embodiment, the surround-sound settings that were used to create the sounds when the headphone characteristics were collected are also stored with the headphone compensation parameters 170, so that a substantially equivalent set of conditions can be reproduced when the user uses the parameters 170 to modify the audio signals provided to the headphones, as detailed below.

FIG. 3 illustrates an example rendering system 300 for recreating an acoustic environment in a headphone-based audio system in accordance with this invention. In the system 300, the surround-sound processor 120 provides conventional channel signals, such as those provided to the loudspeakers 110 in FIG. 2, to a headphone driver 260. As noted above, if the processor 120 allows for a customization of the parameters used to render each channel, the processor 120 is preferably reset to the same set of parameters that were used when the headphone compensation factors 170 were created.

The headphone driver 260 applies the aforementioned headphone compensation factors 170 to modify the conventional channel signals. Preferably, the compensation factors 170 correspond to an inverse of the differences that were detected in the system 200 of FIG. 2, so that, when these factors 170 are applied to the conventional channel signals, the modified audio signals correspond to the modified signals that were detected by the audio detectors 150 of FIG. 2, relative to the amplitude, phase, reverberation, and other effects introduced by the user's environment 100 and the selected ambiance. These modified signals are provided to speakers 250 that are located in a user's headset, thereby recreating the same effects that the user of the system 200 in FIG. 2 experienced via the loudspeakers 110. Note that these effects are produced in the speakers 250 independent of the location of the speakers 250; as long as the headphone speakers 250 of FIG. 3 are placed on the users head consistent with the placement of the detectors 150 of FIG. 2, the effects perceived by the user who is wearing the speakers 250 correspond to the effects that were detected by the detectors 150, regardless of whether the user is in the same environment.

Note also that, assuming consistency among surround-sound systems that are set to the same state, the effects created in the headphone speakers 250 are substantially independent of the specific equipment used to provide the audio signals to the headphone speakers 250. As noted above, the factors 170 are preferably stored in a format that is easy to transfer among rendering systems, so that, for example, the user may use a home-entertainment-system to create a preferred ambiance from which the factors 170 are determined, then subsequently use these factors for achieving the same ambiance via headphones connected to other systems that are configured to apply the factors 170, such as a PDA device, a person's office computer, an MP3-player device, and so on. In the PDA and other processing devices, the headphone driver 260 may be embodied as a software module, while in a portable MP3-player device, the driver 260 may be embodied as a hardware filter. These and other embodiment options will be evident to one of ordinary skill in the art in view of this disclosure.

In a preferred embodiment, the user is provided the option of storing a plurality of sets of headphone compensation factors 170, to facilitate the rendering of a variety of ambiances via headphones. That is, different ambiance settings in a typical surround-sound processor are likely to produce different sets of compensation factors 170 in a given environment 100, or, a user may have different preferred locations relative to the loudspeakers 110 for different ambiances, thereby introducing different phase or reverberation effects. Or, a user may prefer different environments 100 for different simulated ambiances.

In accordance with another aspect of this invention, one or more studios may be made available to a user for use in determining sets of headphone compensation factors. That is, for example, a vendor of headphones may provide an “ideal” setup of loudspeakers 110, and a characterization system 200. A purchaser of the headphones uses the characterization system 200 in this “ideal” environment at the vendor's locale to obtain a set of headphone compensation factors 170, in a portable form, as detailed above. The purchaser also purchases a headphone driver 260, which may be a hardware or software driver, as detailed above. The headphone compensation factors 170 are subsequently used by the driver 260 to drive the headphones from any of one or more of the user's surround-sound systems. In this way, even if a user does not have the space available to provide a proper arrangement of loudspeakers 110 to achieve a realistic surround-sound ambiance, the user can obtain a set of compensation factors 170 for use in a headphone system that will effectively reproduce the ambiance created in the “ideal” setup at the vendor's locale. Providing such a capability serves to distinguish one vendor from another, and/or serves to increase the sales of headphones, headphone drivers, and surround-sound systems. In like manner, the characterization system 200 may be provided by a professional recording studio, for a fee, or at a high-end movie theatre, to increase viewer satisfaction. These and other techniques for gaining a commercial advantage by offering headphone characterization services to users will be evident to one of ordinary skill in the art in view of this disclosure.

FIG. 4 illustrates an alternative example characterization system 200′ for determining headphone compensation factors corresponding to an acoustic environment in accordance with another aspect of this invention. In this embodiment, the channel comparator 160′ compares the signals from the detectors 150 to the source channels L,R that provide the input to the surround-sound processor 120. In this manner, the headphone compensation factors 170′ include the effects provided by the surround-sound system 120, as well as the modifications to the surround-sound signals introduced by the user's environment.

FIG. 5 illustrates a corresponding alternative example rendering system 300′ for recreating an acoustic environment in a headphone-based audio system in accordance with this invention. In this embodiment, the headphone driver 260′ is configured to receive the source channels LR that are typically provided to the surround-sound system 120 of FIG. 4 and modifies these source channels L,R based on the headphone compensation factors 170′ determined by the system 200′ of FIG. 4. Because the factors 170′ correspond to the differences between the source channels L,R and the received sounds after processing via the surround-sound processor 120, the application of these factors 170′ to the source channels L,R provides a reproduction of the effects introduced by the surround-sound processor 120, as well as a reproduction of the effects caused by the environment as the surround-sounds are propagated to the user's head.

One of ordinary skill in the art will note that the principles of this invention are applicable to other sound-effect schemes, in addition to, or in lieu of, the aforementioned recreation of the ambiance produced by loudspeakers of a surround-sound system. Consider, for example, if the user environment includes a waterfall, or other source of flowing water. The detectors 150 will detect these sounds in addition to the sounds produced by the loudspeakers, and these flowing-water-sounds will be included in the difference signals between the audio signals to the loudspeakers 110 and the detectors 150, and therefore in the compensation factors 170, 170′. When the headphone driver 260, 260′ applies these compensation factors to the channel signals, these flowing-water-sounds will be reproduced at the headphones 250. One of ordinary skill in the art will also note that such sound effects need not be detected and processed contemporaneously with the detection and processing of signals from the loudspeakers 110, because such effects are substantially additive to the sounds from the loudspeakers 110. That is, compensation factors corresponding to a particular sound effect can be developed independently, and subsequently combined with the compensation factors developed for the surround-sound system. Alternatively, different sound effects could be made available to the headphone driver for optional mixing with the surround-sound compensation factors as the audio information is being rendered.

Similarly, the sound effects could be “subtractive”, rather than “additive”, to provide for sound-cancellation, or noise-cancellation effects. A user's environment, for example, may be subject to the repetitive sounds of airplanes, subways, and so on. In accordance with the sound-effects aspects of this invention, the user is provided the option of selectively enabling the subtractive application of compensation factors associated with adverse sounds, to reduce the perceived effects of these adverse sounds.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although this invention is presented in the context of an audio entertainment system, the principles of the invention could be applied to other audio-dependent fields, such as gaming, wherein a user creates preferred sets of factors 170 for different games, or for evoking different moods during different stages of a game. In like manner, although the invention is presented in the context of a highly personalized characterization process, previously-determined sets of factors 170 may be provided as general templates, which may optionally be modifiable by a user to create one or more unique sets of factors 170. In such a characterization process, “dummy heads” of varying sizes and shapes may be used in lieu of the user 130 for mounting the detectors 150. Sets of parameters 170 that are found to be particularly effective at achieving a particular ambiance for a wide range of users may be offered to potential users for a fee, or may be included with the sale of headphones or other devices. These and other commercial opportunities, system configurations, and optimization features will be evident to one of ordinary skill in the art in view of this disclosure, and are included within the scope of the following claims.

1. A method of characterizing an acoustic environment, comprising: providing first audio signals to a plurality of loudspeakers within the acoustic environment, detecting second audio signals from a plurality of detectors that are located at known locations relative to a user location, determining a set of compensation factors based on differences between the first audio signals and the second audio signals, and storing the set of compensation factors.

2. The method of claim 1, wherein the plurality of detectors are attached to a fixture that is located at the user location.

3. The method of claim 2, wherein the known locations of the plurality of detectors correspond to locations of speakers on a headphone device.

4. The method of claim 3, further including providing the set of compensation factors to a purchaser of the headphone device.

5. The method of claim 2, wherein the fixture is a head-mounted fixture that is worn by a user at the user location.

6. The method of claim 5, further including providing the set of compensation factors to the user, via a commercial transaction.

7. The method of claim 1, wherein the set of compensation factors include at least one of: a set of amplitude factors, a set of phase factors, and a set of reverberation factors.

8. The method of claim 1, wherein the set of compensation factors include independent sound effects.

9. A characterization systems, comprising: a rendering device that is configured to provide first audio signals to a plurality of loudspeakers, a detector device that is configured to receive second audio signals from a plurality of detectors, and a comparator that is configured to provide compensation factors based on differences between the first audio signals and the second audio signals; wherein the plurality of detectors are located on the detector device at locations corresponding to speakers on a headphone device, and the compensation factors facilitate a recreation of the second audio signals from the first audio signals via the speakers on the headphone device.

10. The characterization system of claim 9, wherein the detector device includes a head-mounted fixture.

11. The characterization system of claim 9, further including a storage device that is configured to store the compensation factors.

12. The characterization system of claim 11, wherein the storage device is configured to store the compensation factors as one of a plurality of sets of compensation factors associated with a user.

13. The characterization system of claim 9, wherein the compensation factors include at least one of: a set of amplitude factors, a set of phase factors, and a set of reverberation factors.

14. The characterization system of claim 9, wherein the rendering device is configured to provide the first audio signals to effect a three-directional audio ambiance.

15. The characterization system of claim 9, wherein the rendering device is configured to provide the first audio signals to the plurality of loudspeakers via a processor that converts the first audio signals into signals that effect a three-dimensional audio ambiance.

16. A rendering system, comprising: a source of a plurality of first audio signals, and a headphone driver that is configured to apply a set of compensation factors to the plurality of first audio signals and to provide therefrom a plurality of second audio signals for driving speakers in a headphone; wherein the compensation factors are derived from a comparison of signals from a plurality of loudspeakers and signals received at a plurality of detectors arranged in a configuration corresponding to the speakers in the headphone.

17. The rendering system of claim 16, wherein the source of the plurality of first audio signals includes a processor that is configured to effect a three-dimensional acoustic ambiance via the first audio signals.

18. The rendering system of claim 16, wherein the compensation factors include at least one of: a set of amplitude factors, a set of phase factors, and a set of reverberation factors.

19. The rendering system of claim 16, wherein the compensation factors include independent sound effects.

20. The rendering system of claim 19, wherein the independent sound effects are subtractive, so as to provide a sound-cancellation effect.
